(19) United States
(12) Patent Application Publication
(10) Pub. No.: US 2010/0148889 A1
(43) Pub. Date: Jun. 17, 2010

(54) HIGH-FREQUENCY COMPONENT HAVING LOW DIELECTRIC LOSSES

(76) Inventors: Peter Bohmer, Malter (DE); Michael Schubert, Dresden (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/597,040

(22) PCT Filed: Apr. 25, 2008
(86) PCT No.: PCT/DE08/00711

§ 371 Date: Feb. 17, 2010

(30) Foreign Application Priority Data
Apr. 25, 2007 (DE) 10 2007 019 447.3

(51) Int. Cl. H01P 5/12

(52) U.S. Cl. 333/134

(57) ABSTRACT

The present invention relates to a high-frequency component with an internal conductor structure (2) which is electrically insulated by at least one insulation element (4, 5) relative to an external conductor, wherein the insulation element (4, 5) mechanically supports the internal conductor structure (2). The insulation element (4, 5) consists of a film (10) shaped to a three-dimensional structure and hardened with this three-dimensional structure by sintering, which film is a film of an electrically insulating material with a wall thickness which is smaller than a thickness of the insulation element (4, 5) realised by the three-dimensional structure. The insulation element of the proposed high-frequency component can be produced inexpensively and leads to a lower insertion loss for the component compared to components made from solid insulation elements.

### TECHNICAL FIELD OF APPLICATION

The present invention relates to a high-frequency component with an internal conductor structure which is electrically insulated by at least one insulation element relative to an external conductor, wherein the insulation element mechanically supports the internal conductor structure.

In high-frequency technology, high-frequency components are often used, in which an internal conductor structure not only has to be insulated relative to the external conductor, but also has to be mechanically supported. Examples for this are filters, couplers, splitters or multiplexers.

So diplexers are used for example between base stations and mobile telephony antennae in order to be able to radiate signals by means of the mobile telephony antennae in various frequency ranges, for example for GSM and UMTS. The diplexer leads to an insertion loss which should turn out to be as low as possible. In known diplexers, the internal conductor structure, which forms the crossover network, is embedded in a sandwich construction between two solid plates made from polytetrafluoroethylene (PTFE). These insulation elements serve the electrical insulation of the internal conductor structure relative to the external conductor which is formed by the housing of the diplexer or is integrated into the same. At the same time, the insulation elements also serve the support or fixing of the often thin internal conductor structure in the housing, in order to ensure a constant defined distance from the external conductor. The material PTFE is used as an insulation material on account of its very low dielectric losses for high-frequency signals, in order to keep the insertion loss due to the diplexer as low as possible. The two plates made from PTFE must be produced very accurately in terms of their thickness however in order to achieve a reliable support or fixing of the internal conductor structure in the housing. This increases the costs for the production of these insulation elements.

The object of the present invention consists in specifying a generic high-frequency component which has a low insertion loss and can be produced inexpensively.

### DESCRIPTION OF THE INVENTION

The object is achieved with the high-frequency component and the insulation element according to the Patent claims 1 and 15 used therein. Advantageous configurations of the high-frequency component and of the insulation element are the subject of the subclaims or can be drawn from the following description as well as from the exemplary embodiments.

The suggested high-frequency component has an internal conductor structure in a known manner, which is electrically insulated by at least one insulation element relative to an external conductor, wherein the insulation element mechanically supports the internal conductor structure. The high-frequency component stands out on account of the fact that the insulation element is formed from a film shaped to a three-dimensional structure and hardened with this three-dimensional structure by sintering, which film is a film of an electrically insulating material, preferably a polymer material, with a wall thickness which is smaller than a thickness of the insulation element realised by the three-dimensional structure. A PTFE film shaped to the three-dimensional structure is preferably used as insulation element in this case.

The requirements on the accuracy of the dimensions of the insulation element are markedly reduced due to the use of the film hardened to the three-dimensional structure. The thickness of this insulation element can here be selected to be somewhat larger than is required for fitting into the housing of the high-frequency component. Due to a certain spring effect or compressibility of the three-dimensional structure, the insulation element can be compressed to exactly the required dimension when closing the housing, wherein the support or fixing of the inner conductor structure, for example a strip conductor structure, is then ensured in an optimal manner. A significant further advantage of the use of the three-dimensional structure consists in the fact that the volume occupied by the insulation element has a markedly smaller proportion of film material than a solid component of the same volume. Thus, the air proportion within this volume can be up to 90% and beyond. On account of the low dielectric loss factor of air for high-frequency radiation in comparison with PTFE or other electrical insulation materials, the loss is reduced compared with the known high-frequency components with solid insulation elements. The same is of course also true if other gases are included in the housing of the high-frequency component. The suggested high-frequency component therefore has lower dielectric losses and can also be produced inexpensively on account of the lower requirements on accuracy during the production of the insulation element(s).

The three-dimensional structure is preferably constructed in the case of the present high-frequency component with a wall thickness of between 50 μm and 500 μm. The wall thickness is of course not fundamentally limited to this thickness range however, as long as the wall thickness is smaller than the thickness of the insulation element. The mechanical stability of the insulation element is achieved in the case of wall thicknesses which are small in this manner by the special shaping of the insulation element, in the case of which the film is prepared in the respective film thickness, three-dimensionally shaped and hardened in the three-dimensional shape by sintering. In this manner, flexurally rigid edges are obtained in the three-dimensional structure, which increase the mechanical stability of the structure.

This technique is explained in even more detail in the following using the preferred material PTFE for the production of the three-dimensional structure, as PTFE in particular is not suitable for well-established plastic processing techniques for producing three-dimensional shaped components on account of its high melt viscosity. In this method, a section of an unsintered PTFE film is brought between a stamp and a die, which exhibit a surface structure for a three-dimensional shaping of the film. The section of the film is then obtained, due to the interaction of stamp and die, in a three-dimensional shape predetermined by the surface structure, whilst it is heated to the sintering temperature of PTFE and permanently hardened in the three-dimensional shape by sintering. Subsequently, the three-dimensionally shaped and hardened section of the film is cooled.

In a particularly preferred configuration, owing to a closed special shaping in the sintering process (the combination of flexurally rigid edges in the plane of the effective loading and a radially symmetrical contouring transversely to the effective loading), the three-dimensionally shaped insulation element obtains much greater shape stability and long-term stability than the thin raw film itself as well as three-dimensional components sintered by open shaping. Flexurally rigid edges in the effective loading plane generate a greater shape stability in the case of identical loading than other contours. The closed, radially symmetric shaping perpendicularly to the effective loading generates a tension buildup in the direction of the contour periphery of the flexurally rigid edges without the formation of tension peaks. This shaping reduces or eliminates the memory effect and leads to a long-term and, up to a critical point, temperature stable geometry of the three-dimensional component with very thin wall thicknesses made from sintered polymer films.

For the clear reduction of the dielectric losses relative to a solid insulation element, the three-dimensional structure is preferably constructed in such a manner that the proportion of the electrically insulating material used in the volume occupied by the insulation element is ≦25%, particularly preferably <10%. This requirement can be set via the wall thickness as well as the course of the three-dimensional structure in certain limits. The three-dimensional structure can here merely run in one direction in a zig-zag shape or a wave shape in simple cases. Basically, in the case of the preferred structure, troughs and peaks alternate with one another, which troughs and peaks can also be constructed concentrically around a centre. The highest regions of the peaks and the deepest regions of the troughs can have any desired shapes here, particularly constructed in a round or angular manner, or even constructed as flat regions. The distance of the troughs and peaks to one another can be constant or vary as desired. Furthermore, more complex three-dimensional structures are of course also possible, as long as the latter still guarantee the required support function of the internal conductor structure.

Preferably, the external conductor is formed by the housing of the high-frequency component or is attached to the inside of this housing, for example as a metallic layer. In the case of high-frequency components in a sandwich construction, in which the internal conductor structure is arranged between two insulation elements, each of these insulation elements is preferably constructed according to the present invention. Here, the one insulation element can have a different structure than the other insulation element. Furthermore, identically structured insulation elements can also be arranged in the high-frequency component rotated by 90° or another angle relative to one another about an axis in the thickness direction, in order to improve the mechanical support of the internal conductor structure as a result.

The present invention can be used for different generic high-frequency components. The function of the component is in this case unimportant, as long as one or a plurality of corresponding insulation elements are required for the electrical insulation and simultaneous support of the internal conductor structure. This principally relates to passive high-frequency components such as diplexers or multiplexers, HF couplers or HF splitters, high-frequency filters, etc. In principle, the use of the suggested insulation element for the support of the internal conductor structure (and electrical components arranged thereon) is also possible in active high-frequency components.

### SHORT DESCRIPTION OF THE DRAWINGS

The present invention is explained briefly once again in the following on the basis of exemplary embodiments in connection with the drawings. Here:

FIG. 1 shows an example for a design of a high-frequency component according to the invention;

FIG. 2 shows an example for the design of a high-frequency component according to the prior art comparable with FIG. 1.

FIG. 3 shows a first example for the three-dimensional structure of an insulation element;

FIG. 4 shows a second example for the three-dimensional structure of an insulation element; and

FIG. 5 shows an example for the production of the three-dimensionally shaped insulation element.

### WAYS OF REALISING THE INVENTION

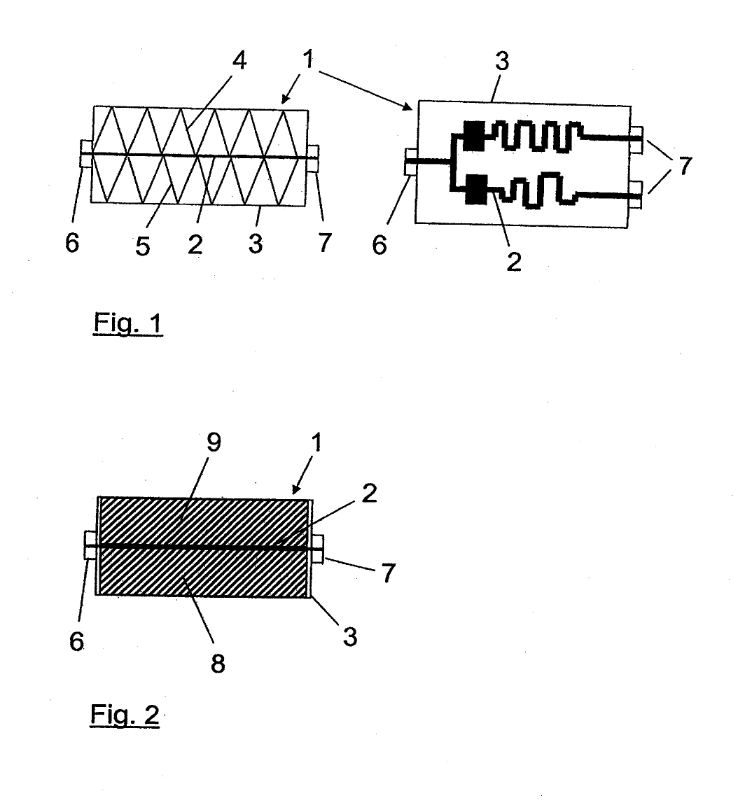

An example of a high-frequency component according to the invention is illustrated schematically in FIG. 1, which high-frequency component is formed as diplexer 1 in this example. The internal conductor structure 2 required for the realisation of a diplexer is only indicated here in a strongly schematised manner. The design of an internal conductor structure for the construction of a diplexer is familiar to the person skilled in the art. The diplexer 1 is to be seen in the left part of the figure in cross section perpendicularly to the internal conductor structure 2 and in the right part of the figure in a section through the plane of the internal conductor structure 2. The housing 3 of the diplexer forms the external conductor. The output 6 and the inputs 7 of the diplexer 1 are indicated in the right part of the figure. According to the present invention, the internal conductor structure 2 is embedded between two insulation elements 4, 5, which on the one hand serve the electrical insulation between the internal conductor structure 2 and the housing 3 as an external conductor and on the other hand serve the mechanical support of the internal conductor structure 2. The two insulation elements 4, 5 are in this example formed from a PTFE film 10 with a thickness of 100 μm shaped to a three-dimensional structure, which film was hardened in the shape of the three-dimensional structure by sintering. The internal conductor structure 2 is supported by these three-dimensional structures, as is to be seen in the left part of FIG. 1. On account of the spring effect of the three-dimensional structures, the thickness of each insulation element 4, 5 can be selected to be somewhat larger than the distance between the internal conductor structure 2 and housing inner wall, wherein the insulation elements 4, 5 can then be compressed easily during the closing of the housing 3. This enables a good fixing or support of the internal conductor structure 2 and reduces the requirements on accuracy for the production of the insulation elements 4, 5.

By comparison thereto, FIG. 2 shows a configuration of a diplexer 1 of this type according to the prior art, in the case of which diplexer the two insulation elements are formed from solid PTFE plates 8, 9. For reliable support of the internal conductor structure 2, these PTFE plates 8, 9 must be produced very accurately in terms of thickness. Furthermore, in spite of the low dielectric losses of PTFE, the solid PTFE plates cause a much greater loss of the high-frequency signals than the insulation elements 4, 5 of FIG. 1, in the case of which a very high air proportion is present between the internal conductor structure 2 and the housing 3. Air causes lower dielectric losses of the high-frequency signals than PTFE, so that the configuration according to FIG. 1 leads to a lower insertion loss.

FIG. 3 finally shows an example of a possible three-dimensional structure of the insulation elements 4 and 5, in the left part of the figure in cross section and in the right part of the figure in a plan view. In this example, the PTFE film 10 is shaped in such a manner that it forms concentric troughs and peaks around a central region, which troughs and peaks are terminated by flat plateaus. The spacings of the peaks and troughs can here be selected differently depending on the application in order to fulfil the respective support function reliably. This support function also depends on the thickness and the ability of the internal conductor structure to support itself.

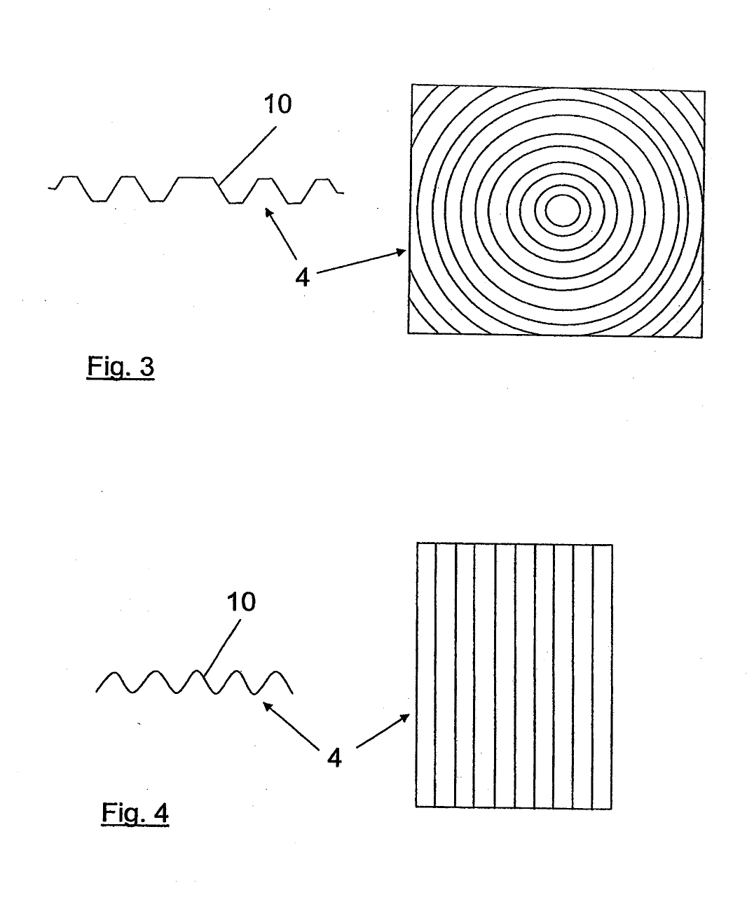

FIG. 4 shows a further example of a configuration of an insulation element 4, 5 of this type. In this example, the PTFE film 10 is shaped to form the three-dimensional structure in a wave like manner in one direction, as this can likewise be seen in the left part of the figure in cross section and in the right part of the figure in a plan view.

It goes without saying that the insulation elements of the high-frequency component suggested are not limited to the structures illustrated here. Rather, any desired three-dimensional structures can be used as long as the required support of the internal conductor structure on the one side and the required distance between the internal conductor structure and the external conductor are guaranteed by these structures.

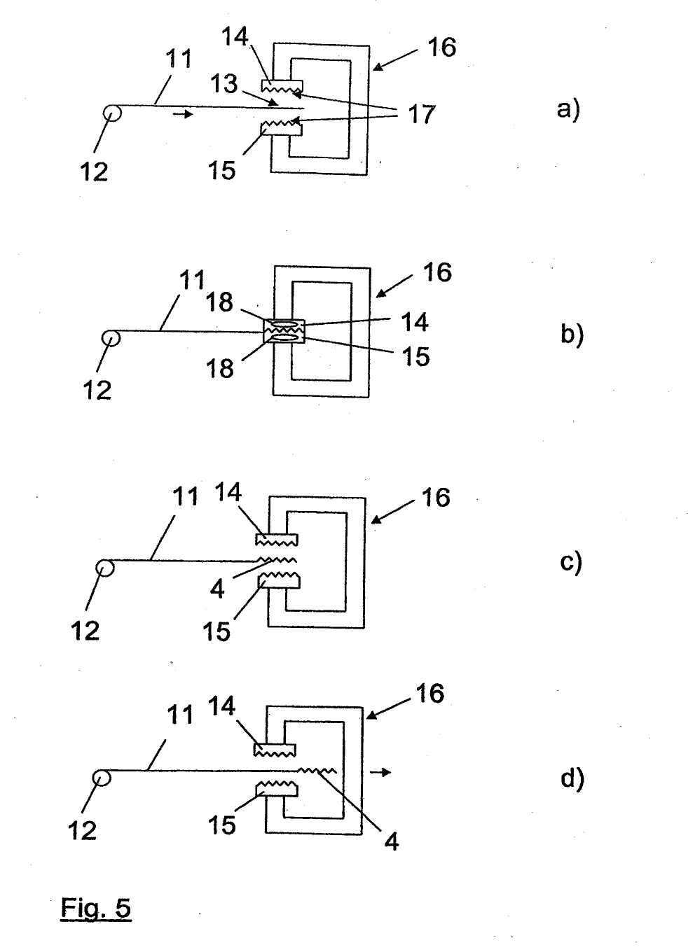

FIG. 5 finally schematically shows a process flow for the production of a three-dimensionally shaped insulation element of this type. In the process an unsintered PTFE film 11 with a thickness of 100 μm is provided on a roll 12 as a semi-finished product, as can be obtained for example by paste extrusion without subsequent sintering.

The section 13 of the film 11 to be shaped is conveyed between the stamp 14 and the die 15 of a hot press 16, as is to be seen in FIG. 5a. Subsequently, stamp 14 and die 15 are moved against one another in the known manner in order to bring the section 13 of the film lying therebetween into a three-dimensional shape in accordance with the surface structure of stamp and die (cf. FIG. 5b). This surface structure 17 is only indicated schematically in FIG. 5. After the bringing together of stamp and die, the section 13 of the film is heated to sintering temperature by means of heating coils 18 integrated into the stamp and die. In the present example, this heating takes place to a temperature in the range between 350° and 360° C., which is optimal for the hardening of the film in the three-dimensional shape. At this temperature, the film section 13 is hardened in the three-dimensional shape by sintering, in which shape it is held due to the interaction of stamp and die. Application of high pressure is not necessary here. Other options for the heating are also possible here, for example by means of a hot air blower or inductively.

After the hardening of the film section 13 by means of the sintering, the film section 13 is cooled. Stamp 14 and die 15 are then moved apart again as is indicated in FIG. 5c. Subsequently, the film 11 is conveyed further, so that the three-dimensionally shaped and hardened section, the three-dimensionally shaped insulation element 4, is moved out of the hot press 16 (FIG. 5d). The finished insulation element 4 can be separated from the rest of the film by suitable separation methods, for example by stamping.

### REFERENCE LIST

1 Diplexer
2 Internal conductor structure
3 Housing
4 Upper insulation element
5 Lower insulation element
6 Output
7 Inputs
8 Lower PTFE plate
9 Upper PTFE plate
10 Hardened PTFE film
11 Unsintered PTFE film
12 Roller
13 Film section
14 Stamp
15 Die
16 Hot press
17 Surface structure
18 Heating coils

1. High-frequency component with an internal conductor structure (2) which is electrically insulated by at least one insulation element (4, 5) relative to an external conductor, wherein the insulation element (4, 5) mechanically supports the internal conductor structure (2),
characterised
in that the insulation element (4, 5) is formed from a film (10) shaped to a three-dimensional structure and hardened with this three-dimensional structure by sintering, which film is a film of an electrically insulating material with a wall thickness which is smaller than a thickness of the insulation element (4, 5) realised by the three-dimensional structure.

2. High-frequency component according to claim 1,
characterised
in that the wall thickness of the three-dimensional structure is between 50 μm and 500 μm.

3. High-frequency component according to claim 1,
characterised
in that the insulation element (4, 5) is formed from a PTFE film (10) shaped to the three-dimensional structure.

4. High-frequency component according claim 1,
characterised
in that the three-dimensional structure is formed in such a manner that a volume occupied by the insulation element (4, 5) has a proportion by volume of ≦25%, preferably of ≦10% of the electrically insulating material.

5. High-frequency component according to claim 1,
characterised
in that the external conductor is formed by a housing (3) or is integrated into a housing (3), in which the internal conductor structure (2) and the insulation element (4, 5) are arranged.

6. High-frequency component according to claim 1,
characterised
in that the three-dimensional structure has a zig-zag shape or a wave-like shape.

7. High-frequency component according to claim 1,
characterised
in that the three-dimensional structure forms peaks and troughs in at least one direction in an alternating manner.

8. High-frequency component according to claim 6,
characterised
in that the three-dimensional structure is radially-symmetrically constructed.

9. High-frequency component according to claim 1,
characterised
in that the internal conductor structure (2) is embedded in a sandwich construction between two of the insulation elements (4, 5).

10. High-frequency component according to claim 9,
characterised
in that the two insulation elements (4, 5) have identical three-dimensional structures and are arranged rotated by an angle, preferably by 90°, relative to one another.

11. High-frequency component according to claim 1, which is constructed as a multiplexer, particularly as a diplexer.

12. High-frequency component according to claim 1, which is constructed as a high-frequency filter.

13. High-frequency component according to claim 1, which is constructed as a high-frequency coupler.

14. High-frequency component according to claim 1, which is constructed as a high-frequency splitter.

15. Insulation element for a high-frequency component according to claim 1,
which is formed from a PTFE film (10) shaped to a three-dimensional structure and hardened with this three-dimensional structure by sintering, which film has a wall thickness which is smaller than a thickness of the insulation element (4, 5) realised by the three-dimensional structure.

16. Insulation element according to claim 15,
in which the wall thickness of the three-dimensional structure is between 50 μm and 500 μm.

17. Insulation element according to claim 15,
in which a volume occupied by the insulation element (4, 5) has a proportion by volume of ≦25%, preferably of ≦10% of the PTFE film (10).

18. Insulation element according to claim 15,
in which the three-dimensional structure forms a zig-zag shape or a wave-like shape.

19. Insulation element according to claim 15,
in which the three-dimensional structure forms peaks and troughs in at least one direction in an alternating manner.

20. Insulation element according to claim 18,
characterised
in that the three-dimensional structure is radially-symmetrically constructed.
